(19) United States
(12) Patent Application Publication
(10) Pub. No.: US 2009/0286498 A1
(43) Pub. Date: Nov. 19, 2009

(54) ANTENNA DIVERSITY RECEIVER AND ANTENNA SWITCHING CONTROL METHOD THEREFOR

(75) Inventor: Satoshi KATAYANAGI, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/467,787

(22) Filed: May 18, 2009

(30) Foreign Application Priority Data
May 16, 2008 (JP) 2008-129629

(51) Int. Cl. H04B 1/06

(52) U.S. Cl. 455/277.2

(57) ABSTRACT

Disclosed is an antenna diversity receiver comprising an antenna switching control unit that includes a noise extraction unit that extracts noise from an FM detection output, a comparator that detects multipath interference from the extracted noise, a switching signal generation unit that outputs, to an antenna switching unit, an antenna switching signal directing switching from one antenna presently in use to another antenna, when multipath interference is detected, a modulation factor detection unit that obtains a modulation factor from the FM detection output, an over-modulation decision unit that decides whether or not the modulation factor is for over-modulation, and a sensitivity setting unit that, when it is decided that there is over-modulation, changes a multipath detection threshold for detecting multipath interference in the comparator, and performs setting to decrease sensitivity of detection of the multipath interference.

### REFERENCE TO RELATED APPLICATION

This application is based upon and claims the benefit of the priority of Japanese patent application No. 2008-129629, filed on May 16, 2008, the disclosure of which is incorporated herein in its entirety by reference thereto.

### TECHNICAL FIELD

The present invention relates to a receiver, and in particular, to an antenna diversity receiver suited to improving reception sound quality by performing reception by switching between a plurality of antennas, and an antenna switching control method therefor.

### BACKGROUND

This type of antenna diversity receiver includes a plurality of antenna systems for a configuration of one FM (Frequency Modulation) receiver. The receiver is adapted to detect high frequency noise included in a detection output signal to switch antennas, thereby realizing preferable reception, with multipath interference being avoided. As an example of this type of antenna diversity receiver, the reference may be done to the description of Patent Document 1.

FIG. 14 is a diagram showing an example of a typical configuration of an antenna diversity receiver. Referring to FIG. 14, the antenna diversity receiver includes at least two systems of antenna 1 and antenna 2, an antenna switching unit 3 that switches antennas, an FM receiver 100, and an antenna switching control unit 101 that directs to the antenna switching unit 3 which antenna is to be selected.

The FM receiver 100 includes an RF front end unit 4 that converts frequency of an FM received wave to an intermediate frequency (IF), an IF filter unit 5 that removes frequency components outside of a target (outside of a desired wave) from the IF signal, an FM detection unit 6 that performs FM detection of the IF signal, and a stereo demodulation unit 7 that demodulates an L component and an R component, based on an FM detection signal, in case a received FM modulation signal is a stereo modulation signal. In FIG. 14, an IF amplifier and a limiter circuit between the IF filter unit 5 and the FM detection unit 6 are omitted.

The antenna switching control unit 101 includes a noise extraction unit 10 that extracts a high frequency noise component included in detection output outputted from the FM detection unit 6, a comparator 11 that judges whether the level of the noise component extracted by the noise extraction unit 10 is greater than or equal to a prescribed threshold and detects whether or not there is multipath interference, and a switching signal generation unit 12 that generates an antenna switching signal, based on a decision result of the comparator 11. The noise extraction unit 10 and the comparator 11 together are referred to as a “multipath interference detection unit”.

An outline of operation of the antenna diversity receiver of FIG. 14 will be described below.

When a received wave is subjected to multipath interference, a distortion occurs in FM detection output (also abbreviated as simply “detection output”) from the FM detection unit 6, and high frequency noise is detected by the noise extraction unit 10.

When the level of high frequency noise extracted by the noise extraction unit 10 exceeds the prescribed threshold, a decision result of “multipath interference is present” is outputted from the comparator 11.

On receipt of the decision result of “multipath interference is present” from the comparator 11, the switching signal generation unit 12 generates an antenna switching signal to switch one antenna used in present reception to another antenna system, and the switching signal generation unit 12 outputs the signal to the antenna switching unit 3.

In the antenna switching unit 3, antenna switching is performed according to the antenna switching signal.

When the multipath interference occurs during reception by the antenna 1, switching to the antenna 2 is performed. Furthermore, when the multipath interference occurs during reception by the antenna 2, switching to the antenna 1 is performed. In this way, since switching control is performed to select an antenna with a good reception state, the multipath interference is avoided, and good reception is realized.

However, in the antenna diversity receiver, when received electric field strength is low, an S/N (signal to noise ratio) deteriorates no matter which antenna is used. Therefore, an antenna to which switching has been performed is not necessarily in a good reception state. For example, in FIG. 14, when the received electric field strength is low, there is a problem in that, if switching from antenna 1 to antenna 2 is performed and the reception state is not still good in antenna 2, switching back to antenna 1 is performed but a good reception state is not obtained, so switching to antenna 2 is again performed, and the like, and that switching of antennas occurs perpetually.

In order to solve this problem, Patent Document 1 proposes a configuration in which output of an interference level detection circuit (corresponding to the noise extraction unit 10 of FIG. 14) is supplied to one input terminal of a comparison circuit (corresponding to the comparator 11 of FIG. 14), output of an electric field level detection circuit is supplied to the other input terminal of the comparison circuit, a reference voltage of the comparison circuit is varied from a strong electric field to a weak electric field in accordance with electric field, and optimal antenna switching is performed in accordance with the electric field strength. In the weak electric field, the reference voltage is increased to make the comparison circuit not easy to operate so that antenna switching is performed only when the SN ratio is quite poor. In the strong electric field, the reference voltage is lowered to make the comparator circuit operate even with a small distortion so that the antenna switching is performed when SN ratio is high.

With regard to documentation disclosing technology relating a part of the invention disclosed in the present document, Patent Document 2, for example, discloses a diversity receiver which appropriately uses a noise detection circuit that has two types of sensitivity, high and low, in accordance with the electric field strength of a received signal, and only when necessary does it perform antenna switching.

Patent Document 3 discloses a diversity receiver that compares an average received signal strength and a switching threshold, and when the received signal strength indication (RSSI) is lower than the switching threshold, switches antenna.

Patent Document 4 discloses a configuration that detects interference by a wireless signal outside of a desired reception frequency (desired wave), and stops antenna switching.

Patent Document 5 discloses a diversity receiver which stops antenna switching during a period in which the antenna input level is lower than a reference level.

Patent Document 6 discloses an antenna receiving system provided with a pulse noise removing circuit that removes pulse noise from output of an FM detector, and a multipath detection circuit that detects noise due to multipath interference from output of the pulse noise removing circuit, and the system responds to a detection signal of the multipath detection circuit, and operates to switch one receiving antenna to another antenna.

Patent Document 7 discloses an antenna receiver system that generates a control signal in accordance with a level of multipath noise, and controls detection sensitivity of a multipath detection circuit according to a control signal.

Patent Document 8 discloses a configuration of a modulation factor detection circuit, and in the configuration disclosed, when the modulation factor is high, a change in amplitude of an IF signal occurs due to out-of-band frequencies being attenuated by an IF filter, and when noise removal processing is performed with regard to this type of signal, signal distortion is generated and deterioration of sound quality is caused, so that the IF signal is outputted without the noise removal processing being performed. Similarly, Patent Document 9 discloses a configuration of an FM receiver which performs control so that, when the modulation factor is high, a noise cancelling operation of removing noise of a detection output signal is stopped.

### [Patent Document 1]

JP Patent Kokai Publication No. JP-A-57-135533

### [Patent Document 2]

JP Patent No. JP2708777

### [Patent Document 3]

JP Patent Kokai Publication No. JP-P2000-295150A

### [Patent Document 4]

JP Patent Utility Model Kokai Publication No. JP-U-60-129761

### [Patent Document 5]

JP Patent Utility Model Kokai Publication No. JP-U-1-108638

### [Patent Document 6]

JP Patent Kokai Publication No. JP-A-56-122528

### [Patent Document 7]

JP Patent Kokai Publication No. JP-A-56-122529

### [Patent Document 8]

JP Patent Kokai Publication No. JP-P2006-333074A

### [Patent Document 9]

JP Patent Kokai Publication No. JP-P2000-49723A

### SUMMARY

The entire disclosures of Patent Documents 1 to 9 are incorporated herein by reference thereto.

The analysis of the related art given by the present invention is as follows.

In general, even in case wherein there is no cause of signal deterioration external to a receiver, such as multipath interference, when a modulation factor of a received FM modulation signal is high, a distortion of FM detection output (this distortion is referred to as “over-modulation distortion” herein) may occur in the receiver, due to for example, an attenuation characteristic of an IF filter 5 of FIG. 14.

FIG. 15 schematically shows a frequency characteristic (spectrum distribution) of an IF signal (output of RF front end unit 4) according to the modulation factor (FIG. 8 in Patent Document 8). When the modulation factor is high, the spectrum distribution of a frequency range of the IF signal becomes broad with respect to bandwidth (corresponding to passband in FIG. 15) of the IF filter, and out-of-band frequency components attenuate due to the IF filter. Due to this, defects in desired reception wave become large, and a distortion occurs in FM detection output.

The distortion of the FM detection output is extracted as a high frequency noise by a noise extraction unit 10, and when the high frequency noise level exceeds a prescribed threshold, the switching signal generation unit 12 generates an antenna switching signal, based on a decision result of the comparator 11.

In the receiver of FIG. 14, with regard to noise due to over-modulation distortion, antenna switching is executed in the same way as with a case wherein the multipath interference occurs. As a result, unnecessary antenna switching is performed, and due to this, reception quality deteriorates.

The configuration of FIG. 14 makes a decision on antenna switching by high frequency noise extraction of detection output by the noise extraction unit 10 and by a decision of high frequency noise level by the comparator 11, even when the modulation factor of the received FM modulation signal is high enough that distortion of the detection output occurs due to the attenuation characteristic of the IF filter unit 5, and is not provided with means for performing switching control according to the modulation factor. As a result, antenna switching (unnecessary antenna switching) is executed also outside of multipath noise.

It is therefore an object of the present invention to provide an antenna diversity receiver and an antenna switching control method for inhibiting unnecessary antenna switching.

The invention, which seeks to solve one or more of the above mentioned problems, is summarized as follows.

According to a first aspect of the present invention, there is provided an antenna diversity receiver that includes an FM detection unit that detects a received signal, and an antenna switching control unit that, when a modulation factor obtained from an output of the FM detection unit is higher than a prescribed threshold, performs control to decrease sensitivity of detection of multipath interference to inhibit antenna switching.

According to another aspect of the present invention, there is provided a method of controlling antenna switching of an antenna diversity receiver, in which a modulation factor is obtained from an FM detection output and, when the modulation factor is higher than a prescribed threshold, control is performed to decrease sensitivity for detecting multipath interference and to inhibit antenna switching.

According to the present invention, it is possible to inhibit unnecessary antenna switching, when the modulation factor of a received FM modulation signal is high.

Still other features and advantages of the present invention will become readily apparent to those skilled in this art from the following detailed description in conjunction with the accompanying drawings wherein only exemplary embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram showing a configuration of a first exemplary embodiment of the present invention.

FIG. 2 is a diagram showing a configuration of a modulation factor detection unit of FIG. 1.

FIG. 3 is a diagram showing operation (time transition of a multipath detection threshold) of a modulation factor detection sensitivity setting unit in the first exemplary embodiment of the invention.

FIG. 4A is a diagram schematically showing a noise waveform extracted by a noise extraction unit and a multipath detection threshold waveform, and FIG. 4B is a diagram schematically showing time transition of an antenna switching signal.

FIG. 5 is a diagram showing a configuration of a modulation factor detection sensitivity setting unit of a second exemplary embodiment of the present invention.

FIG. 6 is a diagram showing operation (time transition of a multipath detection threshold) of a modulation factor detection sensitivity setting unit in the second exemplary embodiment of the invention.

FIG. 7 is a diagram showing a configuration of a modulation factor detection sensitivity setting unit of a third exemplary embodiment of the present invention.

FIG. 8 is a diagram showing operation (time transition of a multipath detection threshold) of a modulation factor detection sensitivity setting unit in the third exemplary embodiment of the invention.

FIG. 9A is a diagram showing an output waveform of a modulation factor detection unit, and FIG. 9B to 9D are drawings showing output waveforms of the modulation factor detection sensitivity setting units of the first to the third exemplary embodiments.

FIG. 10 is a diagram describing a modified example of the third exemplary embodiment of the present invention.

FIG. 11 is a diagram showing a configuration of a fourth exemplary embodiment of the present invention.

FIG. 12 is a diagram showing a configuration of a fifth exemplary embodiment of the present invention.

FIG. 13 is a diagram showing a configuration of a sixth exemplary embodiment of the present invention.

FIG. 14 is a diagram showing a configuration of an antenna diversity receiver.

FIG. 15 is a diagram describing spectral distribution of a frequency domain of an IF signal for high and low modulation factor.

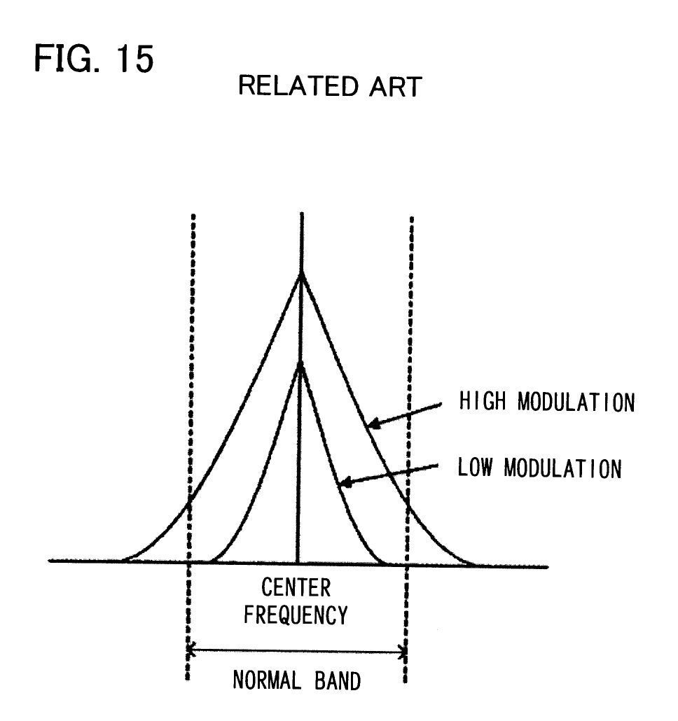

### PREFERRED MODES

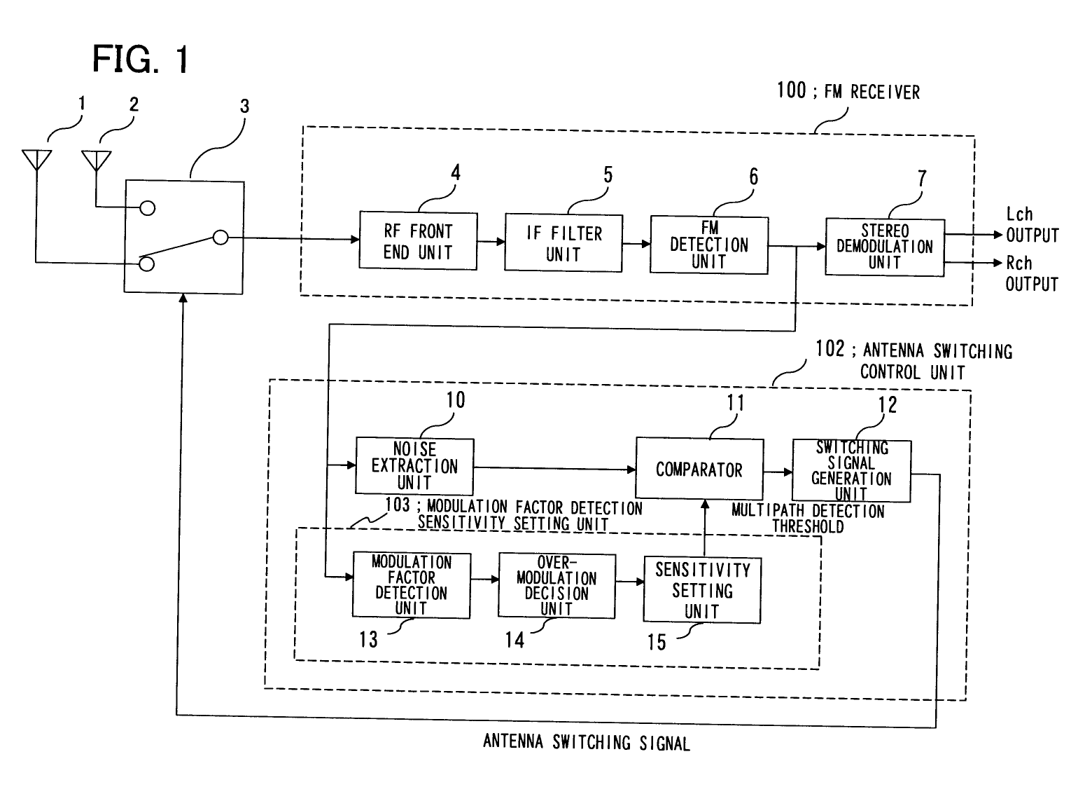

A description is given below to describe in more detail the present invention described above with reference to drawings. In an antenna diversity receiver in accordance with one exemplary embodiment of the present invention, there are provided an antenna switching control unit (for example, 102 in FIG. 1) which, when a modulation factor obtained from an FM detection output is higher than a prescribed threshold, performs control to decrease sensitivity for detecting multipath interference and to inhibit antenna switching.

In more detail, in accordance with one exemplary embodiment of the present invention, the antenna switching control unit (102) includes:

a multipath interference detection unit (including a noise extraction unit 10 and a comparator 11 of FIG. 1, for example) that detects multipath interference from the FM detection output;

a switching signal generation unit (12 in FIG. 1, for example) that generates a signal directing switching from one antenna currently being used for reception to another antenna, when multipath interference is detected by the multipath interference detection unit, and outputs to an antenna switching unit; and

a modulation factor detection sensitivity setting unit (103) that controls setting so as to decrease sensitivity of detection of the multipath interference, in the multipath interference detection unit, when the modulation factor is higher than a prescribed threshold.

In the multipath interference detection unit, the noise extraction unit (10) extracts noise (for example, noise outside of the voice band, harmonic distortion component) from the FM detection output. The comparator (11) compares the level of the noise extracted by the noise extraction unit (10) and a multipath detection threshold for detecting multipath interference, and decides whether or not there is multipath interference; and output of a result of decision by the comparator (11) is supplied to the switching signal generation unit (12).

In an exemplary embodiment of the present invention, the modulation factor detection sensitivity setting unit (103) includes:

a modulation factor detection unit (13) that obtains a modulation factor from output of an FM detector;

an over-modulation decision unit (14) that decides whether or not there is over-modulation in which the modulation factor is higher than the prescribed threshold (that is, in over-modulation, the modulation factor has a value higher than the prescribed threshold); and

a sensitivity setting unit (15) that, when the over-modulation decision unit (14) has decided that there is over-modulation, changes a value of a multipath detection threshold for detecting the multipath interference in the comparator (11) and that makes a setting so as to decrease detection sensitivity for the multipath interference.

In an exemplary embodiment of the present invention, the sensitivity setting unit (15) may set the multipath detection threshold to a first threshold, when the over-modulation decision unit (14) decides that there is no over-modulation, and may set the multipath detection threshold to a second threshold larger than the first threshold, when the over-modulation decision unit (14) decides that there is over-modulation.

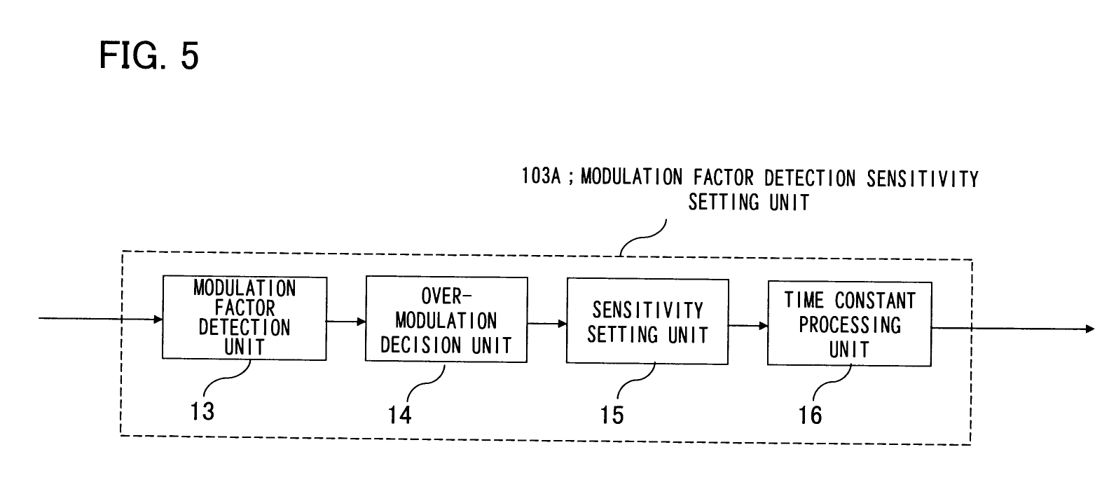

In another exemplary embodiment of the present invention, the modulation factor detection sensitivity setting unit may further include provided a time constant processing unit (16 in FIG. 5) that changes a value of the multipath detection threshold accompanied by a time constant, when the value of the multipath detection threshold from the sensitivity setting unit (15) is changed. An output of the time constant processing unit (16) is supplied to the comparator (11) as the multipath detection threshold. It should be noted that the present invention is not limited to the abovementioned configurations and various types of modifications are possible. A description will be given below according to several specific exemplary embodiments.

### Exemplary Embodiment 1

FIG. 1 is a diagram showing a configuration of a first exemplary embodiment of the present invention. Referring to FIG. 1, an antenna diversity receiver according to the present exemplary embodiment includes at least two antenna systems comprising antenna 1 and antenna 2, an antenna switching unit 3 that switches between the antenna 1 and the antenna 2, an FM receiver 100, and an antenna switching control unit 102 that generates an antenna switching signal indicating to the antenna switching unit 3 which antenna is to be selected.

The FM receiver 100 includes an RF front end unit 4 that converts frequency of an FM received wave to IF (an intermediate frequency), an IF filter unit 5 that removes frequency components outside of a target from an IF signal (intermediate frequency signal), an FM detection unit 6 that performs FM detection on the IF signal, and a stereo demodulation unit 7 that demodulates an L component and an R component, based on an FM detection signal, when a received FM modulation signal is a stereo modulation signal. In FIG. 1, an IF amplifier and a limiter circuit between the IF filter unit 5 and the FM detection unit 6 are omitted. A similar situation applies in drawings that follow.

The antenna switching control unit 102 includes a noise extraction unit 10 that extracts a high frequency noise component included in detection output outputted from the FM detection unit 6, a comparator 11 that checks whether the level of the noise component extracted by the noise extraction unit 10 is greater than or equal to a prescribed threshold to detect whether or not there is multipath interference, a switching signal generation unit 12 that generates an antenna switching signal, based on a decision result of the comparator 11, and a modulation factor detection sensitivity setting unit 103 that detects a modulation factor and sets sensitivity of detection of the multipath interference. The threshold given to the comparator 11 is referred to as a “a multipath detection threshold” herein.

The noise extraction unit 10 includes a high pass filter (not shown in the drawings) that passes components greater than or equal to a frequency cutoff of a prescribed frequency that exceeds the voice band, from the detection output signal from the FM detection unit 6.

The modulation factor detection sensitivity setting unit 103 includes a modulation factor detection unit 13 that detects a modulation factor of a received FM modulation signal from the detection output outputted from the FM detection unit 6, an over-modulation decision unit 14 that compares the modulation factor obtained by the modulation factor detection unit 13 with a prescribed threshold (referred to also as “over-modulation detection threshold”) to decide that there is over-modulation, when the modulation factor is greater than or equal to the prescribed threshold, and a sensitivity setting unit 15 that, when a decision result of the over-modulation decision unit 14 is that of over-modulation, sets a multipath detection threshold to a threshold (a second threshold) obtained by increasing a threshold (a first threshold) for when there is no over-modulation, by a fixed amount.

The modulation factor detection unit 13 performs envelope detection of a voice band within the detection output.

The over-modulation decision unit 14 includes a comparator (not shown) that compares output of the modulation factor detection unit 13 and an over-modulation detection threshold.

The sensitivity setting unit 15 receives an output signal from the over-modulation decision unit 14, selects one of two types of fixed value (the first threshold and the second threshold) that have been decided in advance, and outputs the value to the comparator 11, as the multipath detection threshold.

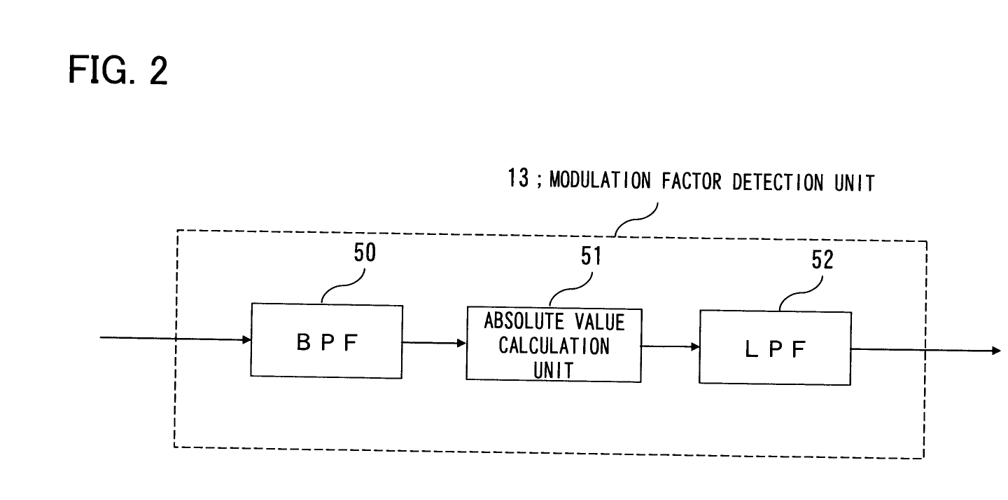

FIG. 2 is a diagram showing one example of a configuration of the modulation factor detection unit 13 of FIG. 1. Referring to FIG. 2, the modulation factor detection unit 13 includes a band pass filter (BPF) 50 that extracts voice band signals from output of the FM detection unit 6, an absolute value calculation unit 51 that obtains an absolute value of amplitude of an output signal of the BPF 50, and a low pass filter (LPF) 52 that obtains an envelope (smoothed signal) of output of the absolute value calculation unit 51. The modulation factor detection unit 13 may receive output of the FM detection unit 6 as input, and output a modulation factor, and clearly is not limited to a configuration of FIG. 2.

Configurations of FIG. 1 and FIG. 2 may be realized by any program (software) that operates in an analog circuit, a digital circuit, a DSP processor (digital signal processor), or the like, or may be realized by a combination of these.

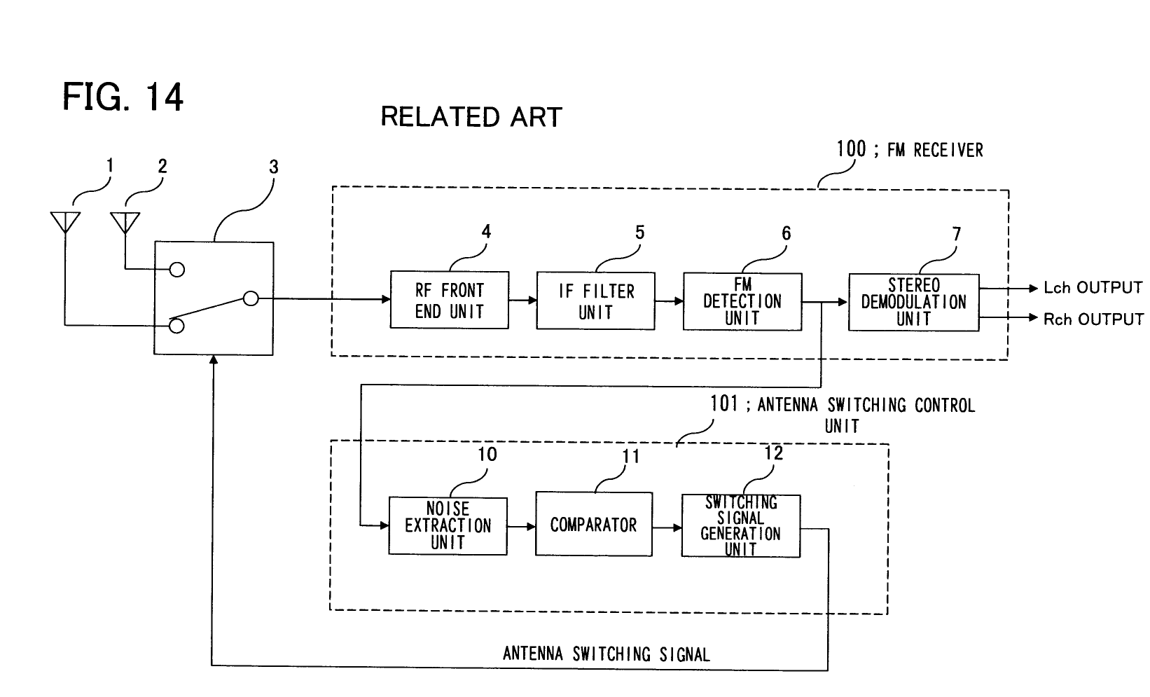

Operation of a first exemplary embodiment of the present invention will now be described. In the first exemplary embodiment of the present invention, similarly to an antenna diversity receiver of FIG. 14, a high frequency signal received by an antenna (the antenna 1 or the antenna 2) selected by the antenna switching unit 3 undergoes frequency conversion to an IF signal, by the RF front end unit 4.

In the IF filter unit 5, frequency components outside of a target are removed from the IF signal from the RF front end unit 4.

In the FM detection unit 6, the IF signal undergoes FM detection, and an FM detected signal, that is, a monaural modulation audio signal or what is called a stereo composite signal, which is a stereo modulation signal, is obtained.

In case where a received FM modulation signal is a stereo modulation signal, the L component and the R component are demodulated based on the FM detection signal (stereo composite signal) in the stereo demodulation unit 7.

When a received wave is subjected to multipath interference, a distortion occurs in the FM detection output, and high frequency noise is extracted by the noise extraction unit 10. In cases in which a high frequency noise level exceeds a multipath detection threshold, a decision result of “multipath interference is present” is displayed by the comparator 11.

The switching signal generation unit 12, on receipt of this decision result, generates an antenna switching signal to switch an antenna which is presently in use for reception, to another antenna.

The modulation factor detection unit 13 detects the modulation factor of the received FM modulation signal from detection output outputted from the FM detection unit 6.

The over-modulation decision unit 14 compares the modulation factor outputted from the modulation factor detection unit 13 with the over-modulation detection threshold (a threshold for judging that the modulation factor is that of over-modulation), and if the modulation factor is greater than or equal to the over-modulation detection threshold, decides that there is over-modulation. The sensitivity setting unit 15 receives the decision result of the over-modulation decision unit 14, and if the received decision result is that of over-modulation, sets the multipath detection threshold to the second threshold obtained by increasing the first threshold for when there is no over-modulation, by a fixed amount.

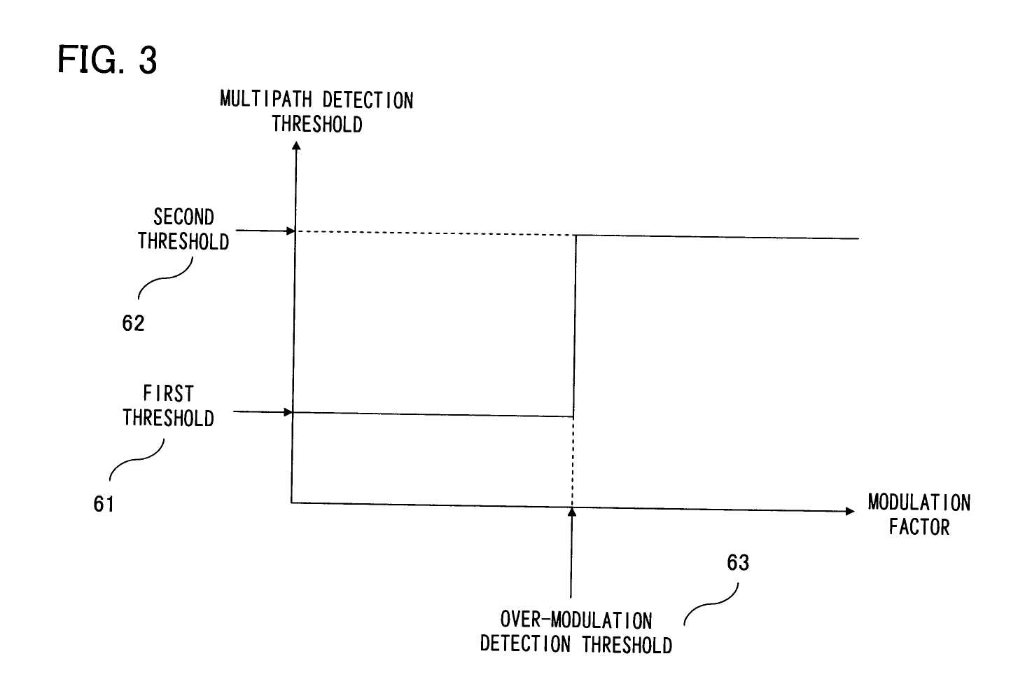

FIG. 3 is a diagram illustrating operation of the over-modulation decision unit 14 and the sensitivity setting unit 15. In FIG. 3, a horizontal axis represents modulation factors (2 values) detected by the modulation factor detection unit 13, and the vertical axis represents level of multipath detection threshold outputted by the sensitivity setting unit 15.

As shown in FIG. 3, when the modulation factor exceeds the over-modulation detection threshold, the sensitivity setting unit 15 outputs the second threshold 62 obtained by increasing the first threshold 61 predetermined for low modulation, by a fixed amount.

As described above, when the modulation factor is high (that is, when the level of an voice signal is large), a distortion occurs in detection output, even if there is no multipath interference, due to an attenuation characteristic of the IF filter unit 5, for example.

Although no particular limitation is imposed on the invention, the over-modulation detection threshold, which is referred to by the over-modulation decision unit 14, may be set to be less than or equal to the value of the modulation factor at which a distortion occurs in the detection output, and adjustment may be performed to set the increased amount (difference between the second threshold 62 and the first threshold 61 of FIG. 3) of the multipath detection threshold at the time of an over-modulation, to be greater than or equal to the approximate size of the distortion of the detection output.

In this case, the distortion of the detection output generated by the over-modulation is less than or equal to the multipath detection threshold (the second threshold 62), in the comparator 11; a decision of “multipath interference is present” is not made; and as a result, switching of the antenna is inhibited (that is, the antenna currently being used to receive a signal is used as it is).

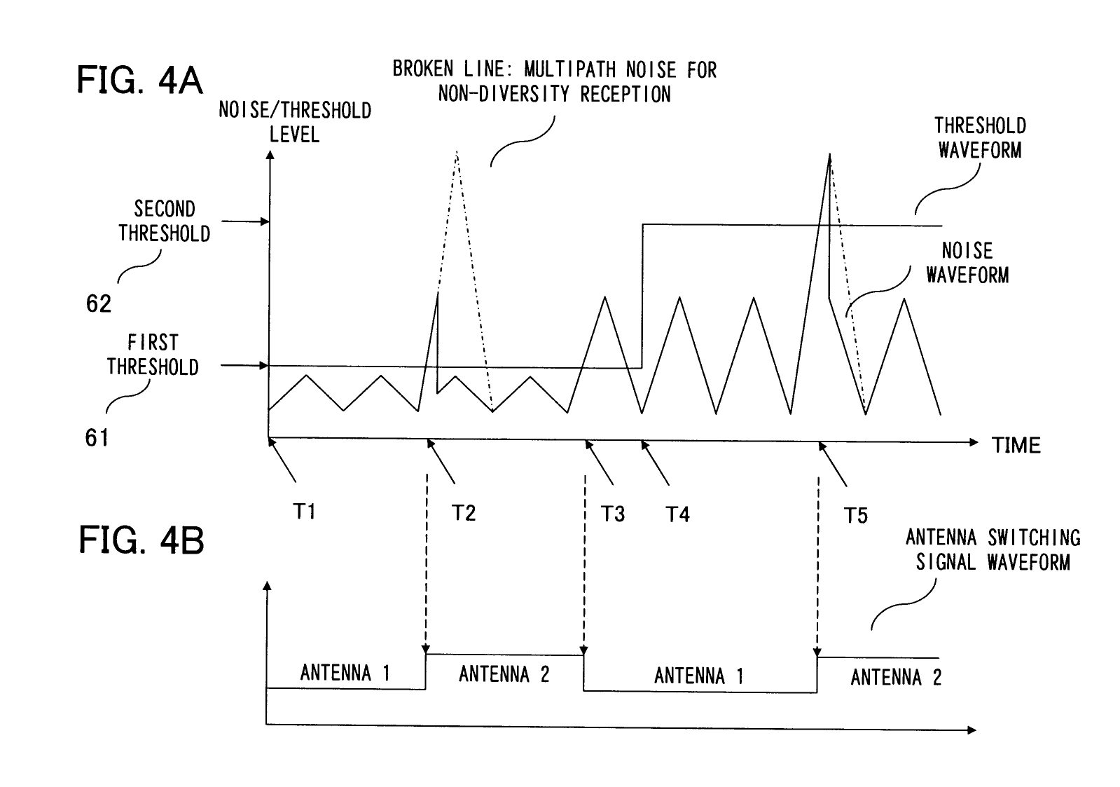

FIG. 4A is a diagram schematically showing noise extracted by the noise extraction unit 10, and a time transition of the threshold (multipath detection threshold) given to the compactor 11, and FIG. 4B is a diagram schematically showing a time transition of an antenna switching control signal.

In FIG. 4, multipath interference occurs at time T2 and at time T5. That is, noise at each of times T2 and T5 is multipath noise, and elsewhere is noise that is not due to the multipath interference, such as normal extraneous noise, noise generated inside a receiver, and the like.

At time T3, the modulation factor of the received FM modulation signal increases, and after time T3, distortion occurs due to the attenuation characteristic of the IF filter unit 5. That is, after time T3, excepting the multipath noise at T2, the noise (level) increases in comparison to before time T3.

In the above conditions, the increase of the modulation factor with regard to time T3 is detected at time T4, by the modulation factor detection unit 13, the over-modulation decision unit 14, and the sensitivity setting unit 15, and the threshold (multipath detection threshold) changes from the first threshold 61 shown in FIG. 4 to the second threshold 62.

With regard to the multipath detection threshold set in this way, the comparator 11 performs decision as to whether or not there is multipath interference, and based on a decision result by the comparator 11, the switching signal generation unit 12 controls switching of antennas. That is, since the modulation factor is low from time T1 to time T2, the first threshold 61 is set as the multipath detection threshold. In this period, since the noise level is low and is lower than the multipath detection threshold, switching of antennas does not take place.

At time T2, multipath noise occurs, and since the noise level exceeds the threshold (the multipath detection threshold) antenna switching takes place. In FIG. 4, as an example, switching from the antenna 1 to the antenna 2 takes place. In FIG. 4A, the multipath noise shown by a broken line at the time T2 position is a noise waveform for cases in which antenna switching does not take place (non-diversity reception). In the present exemplary embodiment, since antenna switching takes place at time T2, the noise waveform is as shown by a full line at the time T2 position. That is, by switching the antenna, both amplitude and time width of the noise waveform are reduced.

At time T3, the multipath noise does not occur, but since noise due to over-modulation distortion exceeds the first threshold 61, antenna switching occurs temporarily. That is, after switching to the antenna 2 at time T2, switching from the antenna 2 to the antenna 1 takes place at time T3.

However, after time T4 at which over-modulation is detected, since the multipath detection threshold is set to the second threshold 62, it is understood that the noise due to the over-modulation distortion does not exceed the multipath detection threshold, and excepting the multipath interference at time T5, antenna switching does not occur.

As exemplified at time T5, when the noise due to the multipath interference is large to the extent of exceeding the second threshold 62, even in over-modulation conditions, antenna switching is possible. At time T5, switching from the antenna 1 to the antenna 2 takes place.

The occurrence of the distortion in the detection output when the modulation factor is high is taken as being due to the IF filter unit 5, but this is only to illustrate a simple example for purposes of description. In a general receiver, the distortion occurs due to what is called nonlinearity of a receiving apparatus, in the path from the antenna to the FM detection unit. Furthermore, the over-modulation may be used as a term that indicates a modulation state (mainly with regard to a transmitted wave) that exceeds a maximum frequency shift prescribed for FM broadcasting and the like, but herein, irrespective of a prescription of the maximum frequency shift, a high modulation state (mainly with regard to a received wave) that accompanies deterioration of reception quality (for example, when a distortion occurs) due to the abovementioned nonlinearity of the receiving apparatus, is treated as over-modulation. That is, the modulation factor indicates over-modulation in case of being greater than or equal to a value set in advance as an over-modulation detection threshold.

As described above, the first exemplary embodiment of the present invention includes the modulation factor detection unit 13 that detects a modulation factor of a received FM modulation signal from detection output that is outputted from the FM detection unit 6, an over-modulation decision unit 14 that compares the modulation factor obtained by the modulation factor detection unit 13 with a prescribed threshold (over-modulation detection threshold) to decide that there is over-modulation when the modulation factor is greater than or equal to the prescribed threshold (over-modulation detection threshold), and a sensitivity setting unit 15 that, when the decision result of the over-modulation decision unit 14 is that of over-modulation, sets the threshold of the comparator 11 to be increased by a fixed with respect to when there is no over-modulation; and antenna switching in reaction to over-modulation distortion is not carried out, so as to increase the threshold for the comparator 11 with regard to a received wave signal of a modulation factor with which a distortion occurs in the detection output. As a result, unnecessary antenna switching (antenna switching in reaction to noise due to over-modulation distortion) is inhibited.

### Exemplary Embodiment 2

FIG. 5 is a diagram showing a configuration of a modulation factor detection sensitivity setting unit 103A in a second exemplary embodiment of the present invention. Referring to FIG. 5, in the present exemplary embodiment, the modulation factor detection sensitivity setting unit 103A includes, in addition to the configuration of the abovementioned first exemplary embodiment of FIG. 1, a time constant processing unit 16 that transmits a waveform, in which output of a sensitivity setting unit 15 is made blunted with a fixed time constant, to a comparator 11.

When output (multipath detection threshold) of the sensitivity setting unit 15 increases, the time constant processing unit 16 blunts a rising waveform according to what is called an attack time constant, and transmits to the comparator 11.

Moreover, when output of the sensitivity setting unit 15 decreases, the time constant processing unit 16 blunts a falling waveform according to what is called a release time constant, and transmits to the comparator 11.

The time constant processing unit 16 is similar in operation to a general low pass filter, excepting the fact of having a different time constant with regard to each of an increase (rise) and a decrease (fall) of a multipath detection threshold outputted from the sensitivity setting unit 15.

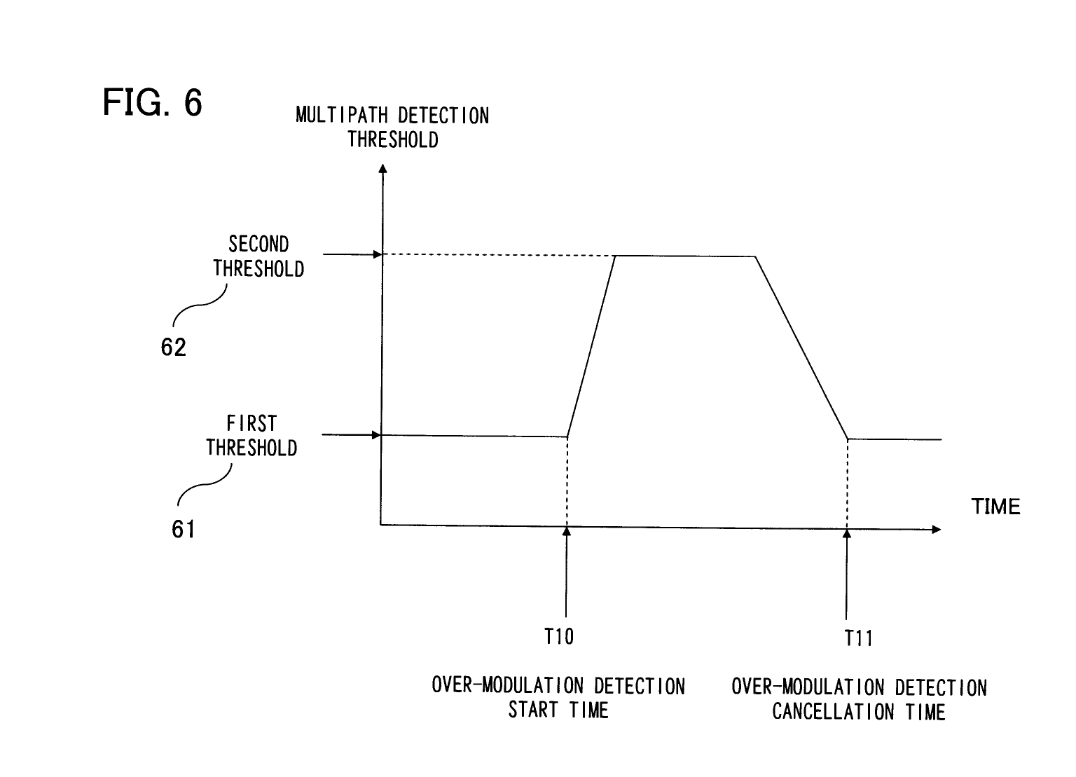

FIG. 6 is a diagram showing operation of the modulation factor detection sensitivity setting unit 103A in the second exemplary embodiment of the present invention. In FIG. 6, a horizontal axis indicates time and a vertical axis indicates the multipath detection threshold, and time transition of the multipath detection threshold is shown. As shown in FIG. 6, in the modulation factor detection sensitivity setting unit 103A, at time T10, when an over-modulation distortion is detected by the over-modulation decision unit 14, accompanying an attack time constant in the time constant processing unit 16, the multipath detection threshold is gradually increased from a first threshold 61 towards a second threshold 62, and at time T11, when detection of the over-modulation is cancelled, accompanying a release time constant in the time constant processing unit 16, the multipath detection threshold is gradually decreased from the second threshold 62 towards the first threshold 61.

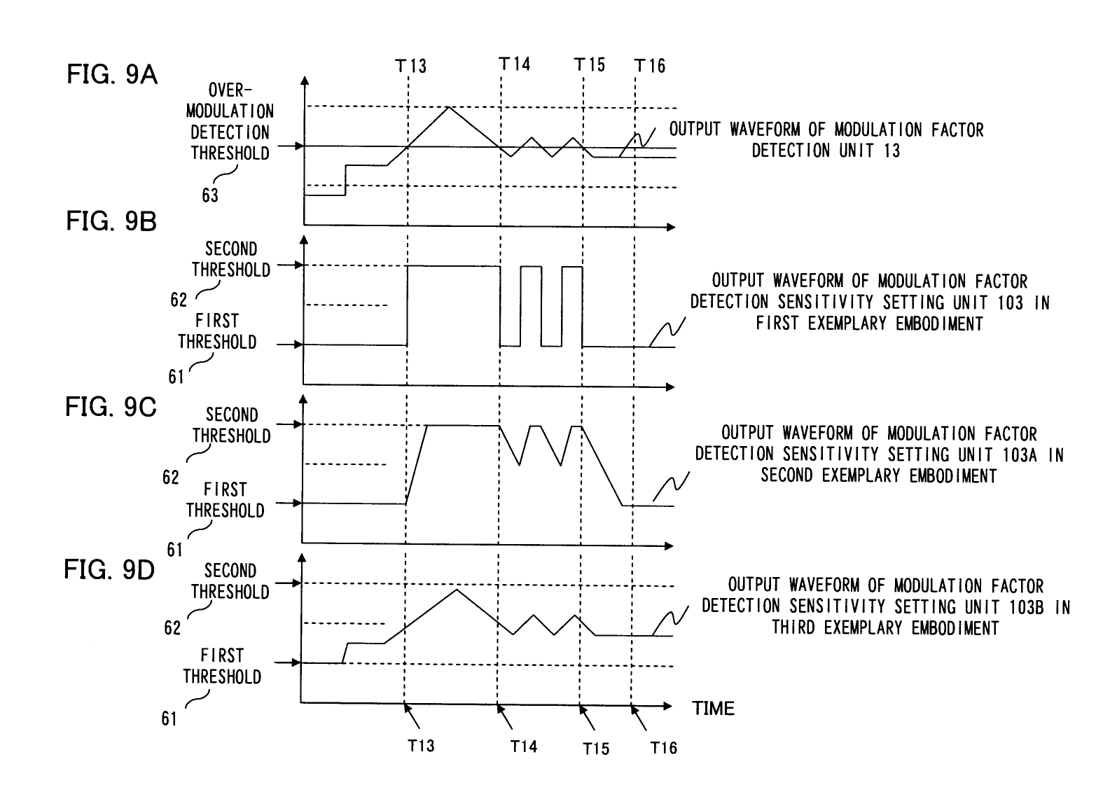

In the abovementioned first exemplary embodiment shown in FIG. 3, switching the multipath detection threshold between the first threshold 61 and the second threshold 62 is carried out instantly, but in the present exemplary embodiment, increasing and decreasing between the first threshold 61 and the second threshold 62 are carried out gradually. The first exemplary embodiment and the present exemplary embodiment are further described below, making reference to FIG. 9.

### Exemplary Embodiment 3

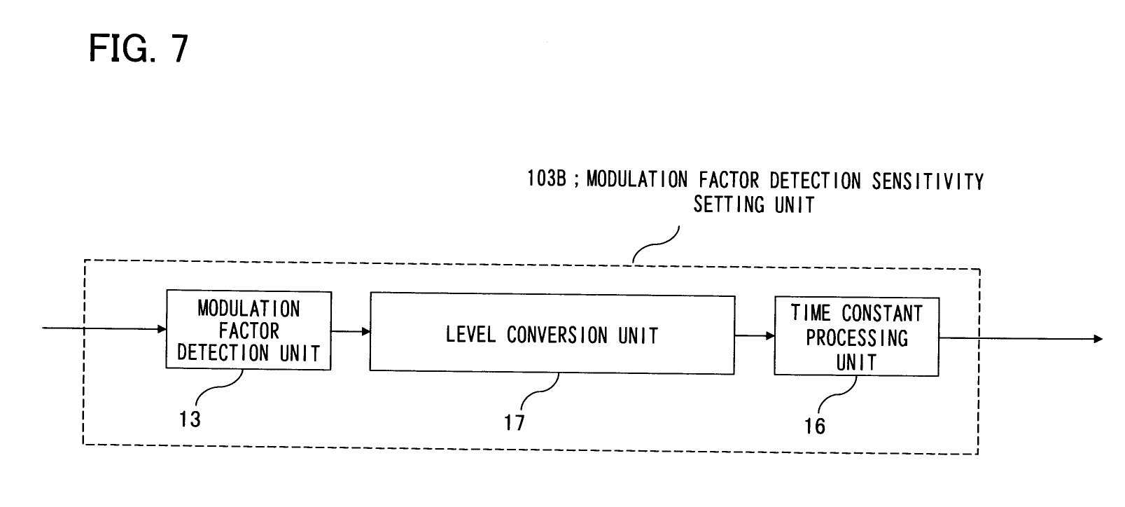

FIG. 7 is a diagram showing a configuration of a modulation factor detection sensitivity setting unit 103B in a third exemplary embodiment of the present invention. In the present exemplary embodiment, with regard to the modulation factor detection sensitivity setting units 103 and 103A of the first and the second exemplary embodiments of the present invention shown in FIG. 1 and FIG. 5, the over-modulation decision unit 14 and the sensitivity setting unit 15 are replaced by a level conversion unit 17. The level conversion unit 17 determines a multipath detection threshold in accordance with a modulation factor from a modulation factor detection unit 13. The modulation factor is outputted from the modulation factor detection unit 13, and the level conversion unit 17 outputs the modulation factor whose level value has been changed, as a multipath detection threshold.

Output of the level conversion unit 17 is processed by a time constant processing unit 16 described in the abovementioned second exemplary embodiment, and with regard to the multipath detection threshold from the modulation factor detection sensitivity setting unit 103B, when there is a change, a waveform associated with a time constant is outputted. In a modified example of the present exemplary embodiment, the time constant processing unit 16 is eliminated, and the output of the level conversion unit 17 may be given to the comparator 11 of FIG. 1, as the multipath detection threshold from the modulation factor detection sensitivity setting unit 103B.

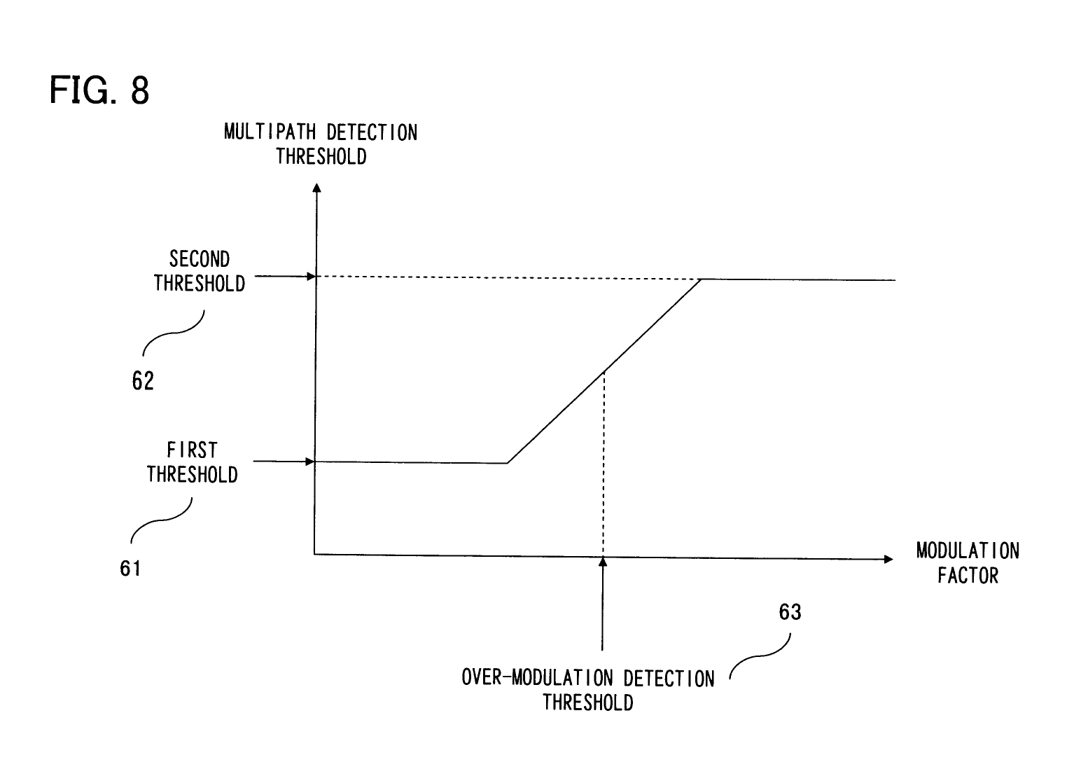

FIG. 8 shows an input-output characteristic of the level conversion unit 17 of FIG. 7. In FIG. 8, a horizontal axis indicates the modulation factor, and a vertical axis indicates the multipath detection threshold. As shown in FIG. 8, the level conversion unit 17 outputs a value (level) that changes continuously and that follows a curve (or a straight line) monotonically increasing between a first threshold 61 and a second threshold 62, before and after an over-modulation detection threshold 63, with respect to a modulation factor received from the modulation factor detection unit 13.

The level conversion unit 17 can be configured from a calculation means that obtains a prescribed linear function (ax+b) having the modulation factor as a variable (x), and an output limiting means that performs output only when a computation result of the calculation means is a value between the first threshold 61 and the second threshold 62. A characteristic shown in FIG. 8 is linear (linear function), but as long as the function increases monotonically, any function may be used.

In the third exemplary embodiment of the present invention, by providing the level conversion unit 17, it is possible to associate output of the modulation factor detection sensitivity setting unit 103B, that is, the multipath detection threshold referred to in order for a decision to be made concerning antenna switching by the comparator 11, with change of the modulation factor, and to finely (with high accuracy and high resolution) perform change.

### Comparison of First, Second, and Third Exemplary Embodiments

FIG. 9A is a diagram showing an output waveform (time transition of the modulation factor) of the modulation factor detection unit 13 and an over-modulation detection threshold of the over-modulation decision unit 14.

FIG. 9B is a diagram showing one example of an output waveform (time transition of the multipath detection threshold) of the modulation factor detection sensitivity setting unit 103 of the first exemplary embodiment, with regard to transition of the modulation factor of FIG. 9A.

FIG. 9C is a diagram showing one example of an output waveform (time transition of the multipath detection threshold) of the modulation factor detection sensitivity setting unit 103A of the second exemplary embodiment, with regard to transition of the modulation factor of FIG. 9A.

FIG. 9D is a diagram showing one example of an output waveform (time transition of the multipath detection threshold) of the modulation factor detection sensitivity setting unit 103B of the third exemplary embodiment, with regard to transition of the modulation factor of FIG. 9A.

In FIG. 9A, an example is shown of states in which the modulation factor detected by the modulation factor detection unit 13 goes above the over-modulation detection threshold 63 at time T13, becomes less than the over-modulation detection threshold 63 at time T14, fluctuates while frequently crossing the over-modulation detection threshold 63 in a period from time T14 to time T15, and is continuously less than the over-modulation detection threshold 63 after time T15.

Based on the above conditions, in the first exemplary embodiment of the present invention, the output (multipath detection threshold) of the modulation factor detection sensitivity setting unit 103, as may be seen from after time T14, frequently crosses the over-modulation detection threshold 63, irrespective of the fact that change of the modulation factor is not large, so as to switch frequently between the first threshold 61 and the second threshold 62. The multipath detection threshold referred to by the comparator 11 frequently switches (non-continuous change) between the first threshold 61 and the second threshold 62 with a short cycle, so that there is a possibility that unstable change of antenna switching frequency will occur and a user will sense a slight acoustic discomfort.

In the second exemplary embodiment of the present invention, since, in the time constant processing unit 16, the waveform of the multipath detection threshold is made blunted, output (multipath detection threshold) of the modulation factor detection sensitivity setting unit 103A does not suddenly change as in the first exemplary embodiment. At time T13, there is a gradual increase towards the second threshold 62, accompanied by an attack time constant in the time constant processing unit 16. From time T14 to time T15, when the modulation factor fluctuates in a vicinity of the over-modulation detection threshold 63, transition is more gradual and continuous than in the first exemplary embodiment. At time T14 when the modulation factor becomes less than the over-modulation detection threshold 63, and gradually decreases accompanied by a release time constant from the second threshold 62, and at an intermediate point before decreasing from the second threshold 62 to the first threshold 61, when the modulation factor exceeds the over-modulation detection threshold 63, the modulation factor gradually increases from the intermediate point and reaches the second threshold 62, accompanied by the attack time constant; when the modulation factor fluctuates in the vicinity of the over-modulation detection threshold 63, the output (multipath detection threshold) of the modulation factor detection sensitivity setting unit 103A does not decrease as far as the first threshold 61. After time T15, the modulation factor gradually decreases towards the first threshold 61 with a waveform change accompanied by the release time constant.

As is understood from FIG. 9B and FIG. 9C, by the second exemplary embodiment of the present invention, with regard to the first exemplary embodiment, being newly provided with the time constant processing unit 16, it is possible to more continuously change output of the modulation factor detection sensitivity setting unit 103A, that is, the multipath detection threshold that is a reference for an antenna switching judgment in the comparator 11. As a result, to alleviate the user's sense of unnaturalness when hearing, it is possible to change the antenna switching frequency more stably.

In addition, as shown in FIG. 9D, in the third exemplary embodiment of the present invention, a multipath detection threshold that changes continuously in response to the modulation factor is outputted. Furthermore, as is seen at time T16, in the first and the second exemplary embodiments, when the modulation factor is less than the over-modulation detection threshold, the multipath detection threshold eventually decreases as far as the first threshold 61, but in the third exemplary embodiment, the multipath detection threshold does not decrease as far as the first threshold 61, and output in accordance with the modulation factor is obtained.

In the third exemplary embodiment, by providing the level conversion unit 17, it is possible to more finely change output of the modulation factor detection sensitivity setting unit 103B, that is, the multipath detection threshold related to antenna switching. That is, it is possible to more stably change the antenna switching frequency.

According to each of the abovementioned exemplary embodiments, since it is possible to detect that the modulation factor of the received FM modulation signal is high and to set the multipath detection threshold related to the antenna switching to a high value, it is possible to inhibit unnecessary antenna switching and to decrease noise related to the antenna switching.

Moreover, in the second and the third exemplary embodiments of the present invention, since it is possible to control more continuously the multipath detection threshold related to antenna switching, it is possible to alleviate a sense of unnaturalness when hearing.

### Modified Example of Exemplary Embodiment 3

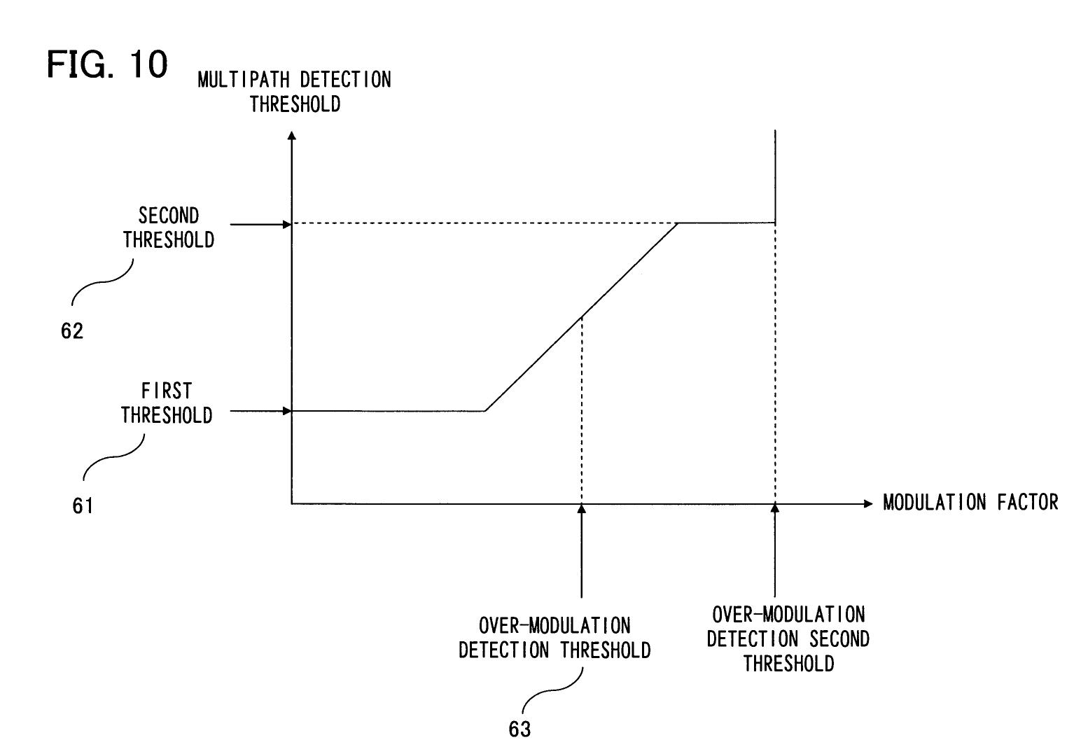

FIG. 10 shows a modified example of an input-output characteristic (input: modulation factor; output: multipath detection threshold) of the level conversion unit 17 of FIG. 7. As shown in FIG. 10, the level conversion unit 17 outputs a value that changes continuously, following a curve that monotonically increases between a first threshold 61 and a second threshold 62, before and after a over-modulation detection threshold 63, with respect to an inputted modulation factor. When the modulation factor inputted to the level conversion unit 17 reaches an over-modulation detection second threshold, the multipath detection threshold is set to a value larger than the second threshold 62. In such cases, when the multipath detection threshold is set sufficiently larger than a normally assumed maximum value of the over-modulation distortion or a maximum value of the multipath interference level (ideally at infinity), a signal level received by the comparator 11 is always smaller than the multipath detection threshold, and a decision of “multipath interference is present” is not outputted from the comparator 11. Therefore, antenna switching does not take place.

That is, in the present exemplary embodiment, it is possible to arrange such that the antenna switching does not take place, with regard to a modulation factor (level) greater than or equal to the over-modulation detection second threshold. In cases in which a very large interference (noise) or the like occurs due to some issue, this type of configuration can detect an abnormal increase of the modulation factor accompanying the interference (noise), and forcibly stop the antenna switching. As a result, it is possible to inhibit the occurrence of abnormal antenna switching, and to stabilize behavior of a receiver.

In the abovementioned exemplary embodiments, there are illustrated examples of configurations in which the antenna switching is stopped according to a level conversion characteristic of the level conversion unit 17. However, it is as a matter of course possible to adopt such a configuration in which, when the modulation factor inputted to the level conversion unit 17 has reached the over-modulation detection second threshold, antenna switching operation may be stopped logically (for example, stopping of the antenna switching operation of a switching signal generation unit 12, or the like). Furthermore, the configuration may be such that, when the antenna switching operation is stopped, the switching signal generation unit 12 selects a predetermined, prescribed antenna. As one example, a gate circuit (not shown) that controls transmission-masking of a decision result from the comparator 11 to the switching signal generation unit 12, is provided. When the modulation factor reaches the over-modulation detection second threshold, the level conversion unit 17 controls the gate circuit and masks the decision result from the comparator 11 so that the gate circuit (not shown in the drawings) does not transmit the decision result of “multipath interference is present” from the comparator 11 to the switching signal generation unit 12 but supplies the decision result of “multipath interference is not present” to the switching signal generation unit 12. The configuration may be such that in the switching signal generation unit 12, which receives the decision result of “multipath interference is not present”, an antenna being used for present reception continues to be used as it is, or an antenna determined in advance is selected. In such cases, in the switching signal generation unit 12, an antenna switching operation is stopped (suspended) by control from the level conversion unit 17 of the modulation factor detection sensitivity setting unit 103B.

### Exemplary Embodiment 4

When electric field strength of a desired received wave (referred to below for convenience as a weak electric field) is small, as can be seen in Patent Document 1, or when there is interference (referred to as “adjacent interference”) due to a wireless signal outside of a desired reception frequency, whichever antenna is used, S/N deteriorates, and continual switching occurs. These issues may occur independently of a problem of the frequent occurrence of antenna switching when the modulation factor is high (referred to as “high modulation” herein), mentioned above. Therefore, it is desirable that a receiver be combined with a means for solving these issues at the same time.

In related art, there are references to individual problems, and when a multipath-related detection threshold is set for each problem, for example, there is no mention of how to adjust a multipath detection threshold computed with regard to these individual problems. How to carry out such adjustments is a problem with regard to configuration of the receiver. Therefore, in a fourth exemplary embodiment of the present invention, there is provided an antenna diversity receiver which includes an antenna switching control unit that can cope with each of conditions:

(A) high modulation;

(B) weak electric field; and

(C) adjacent interference.

The antenna diversity is so adapted to perform arbitration among respective control and function for the conditions.

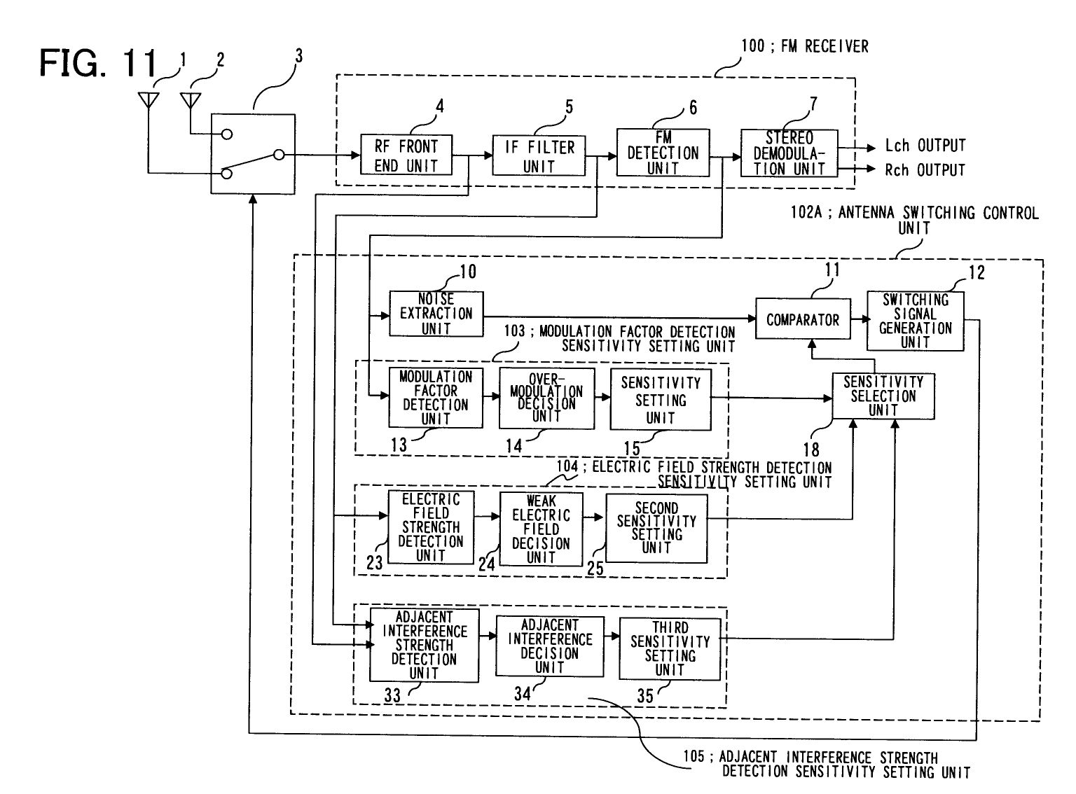

FIG. 11 is a diagram showing a configuration of the fourth exemplary embodiment of the present invention. Referring to FIG. 11, the fourth exemplary embodiment of the present invention, with respect to the first to the third exemplary embodiments, includes an electric field strength detection sensitivity setting unit 104 that detects the electric field strength of a desired received wave and calculates a multipath threshold, and an adjacent interference strength detection sensitivity setting unit 105 that detects the level of adjacent interference and calculates a multipath threshold.

In addition, there is provided a sensitivity selection unit 18 that selects, among multipath detection thresholds computed by each of a modulation factor detection sensitivity setting unit 103, the electric field strength detection sensitivity setting unit 104, and the adjacent interference strength detection sensitivity setting unit 105, the largest threshold (a threshold at which sensitivity of detection of the multipath interference is most blunted).

In FIG. 11, the modulation factor detection sensitivity setting unit 103 is shown represented by a configuration of the abovementioned first exemplary embodiment. However, it is as a matter of course that the configuration of the abovementioned second or third exemplary embodiment is adopted.

The electric field strength detection sensitivity setting unit 104 includes an electric field strength detection unit 23 that detects the electric field strength of the desired received wave, a weak electric field judging unit 24 that judges a weak electric field when the electric field strength detected by the electric field strength detection unit 23 is compared with a predetermined threshold and the electric field strength is less than or equal to the threshold, and a second sensitivity setting unit 25 that obtains a multipath detection threshold based on a decision result of the weak electric field judging unit 24.

The electric field strength detection unit 23 performs detection by a method of envelope detection (it is desirable to perform logarithmic conversion of an obtained result) of an output level of an IF filter unit 5, for example. The weak electric field judging unit 24 is configured by a comparator or the like that compares the electric field strength and the predetermined threshold. The second sensitivity setting unit 25 is configured similarly to a sensitivity setting unit 15 of the first exemplary embodiment.

The electric field strength detection sensitivity setting unit 104 may be configured to include a time constant processing unit and a level conversion unit as may be seen in the second and the third exemplary embodiments, similar to the modulation factor detection sensitivity setting unit 103.

As one example of a configuration of the adjacent interference strength detection sensitivity setting unit 105, there is provided an adjacent interference strength detection unit 33 that detects an adjacent interference level, an adjacent interference judging unit 34 that decides that an adjacent interference is present when an adjacent interference level detected by the adjacent interference strength detection unit 33 is compared with a predetermined threshold and the adjacent interference level is greater than or equal to the threshold, and a third sensitivity setting unit 35 that obtains a multipath detection threshold based on a decision result of the adjacent interference judging unit 34.

The adjacent interference strength detection unit 33, similar to Patent Document 4, for example, detects received signal strength of a wide area by performing envelope detection of output of an RF front end unit 4, and detects received signal strength of a narrow area, that is a desired received wave, by performing envelope detection of output level of the IF filter unit 5, and calculates a level comparison of these (difference among respective logarithmic conversions of the envelope detections is also possible), to obtain adjacent interference level.

The adjacent interference judging unit 34 is configured by a comparator or the like that compares the adjacent interference level and a predetermined threshold. The third sensitivity setting unit 35 is configured similarly to the sensitivity setting unit 15 of the first exemplary embodiment.

The adjacent interference strength detection sensitivity setting unit 105 may well be configured to include a time constant processing unit and a level conversion unit as may be seen in the second and the third exemplary embodiments, similar to the modulation factor detection sensitivity setting unit 103.

The sensitivity selection unit 18 adjusts multipath detection thresholds computed by each of the modulation factor detection sensitivity setting unit 103, the electric field strength detection sensitivity setting unit 104, and the adjacent interference strength detection sensitivity setting unit 105, to perform a setting as a multipath detection threshold for the comparator 11.

The sensitivity selection unit 18 selects a maximum value from among the multipath detection thresholds computed by each of the modulation factor detection sensitivity setting unit 103, the electric field strength detection sensitivity setting unit 104, and the adjacent interference strength detection sensitivity setting unit 105. The reason for this is described as follows.

At least a few types of adjustment method for the sensitivity selection unit 18 can be employed:

(A) addition

(B) average, weighted average

(C) selection of a maximum value

(D) selection of a minimum value

First, a case of (D) selection of the minimum value will be explained. In case where the electric field strength is high, and there is high modulation, for example, since a threshold according to the electric field strength is set low and an effect of implementing modulation factor detection disappears, this is not preferable.

In a case of (B) average or weighted average, in which the electric field strength is high, and there is high modulation, since a threshold according to the electric field strength is set low and an effect of implementing modulation factor detection is weak, this is not preferable.

In a case of (A) addition, in which there is a weak electric field and high modulation, since a threshold is doubly set and a multipath threshold becomes excessively large, the multipath detection becomes excessively insensitive, which is not preferable.

In (C) selection of the maximum value, by selecting the largest threshold from among the multipath detection thresholds obtained according to respective causes of high modulation, weak electric field, and adjacent interference, the multipath detection does not become excessively insensitive, and various detection effects do not become excessively insensitive so that it is possible to set an optimum multipath detection threshold in accordance with reception conditions.

As shown in the present exemplary embodiment, when the multipath detection threshold is obtained by a plurality of factors and these are utilized at the same time, the sensitivity selection unit 18 in the maximum value selection method functions as a preferable threshold adjustment means.

According to the fourth exemplary embodiment of the present invention as described above, by establishing the sensitivity selection unit 18 that selects the maximum threshold from among the multipath detection thresholds computed by each of the modulation factor detection sensitivity setting unit 103, the electric field strength detection sensitivity setting unit 104, and the adjacent interference strength detection sensitivity setting unit 105, it is possible to detect high modulation, a weak electric field, and adjacent interference, and to appropriately set the multipath detection threshold computed based on the respective conditions to the comparator 11. As a result, it is possible to provide an antenna diversity receiver in which antenna switching is implemented using an optimal multipath detection threshold in response to reception conditions, and which has an effect of enabling preferable control of antenna switching frequency.

### Exemplary Embodiment 5

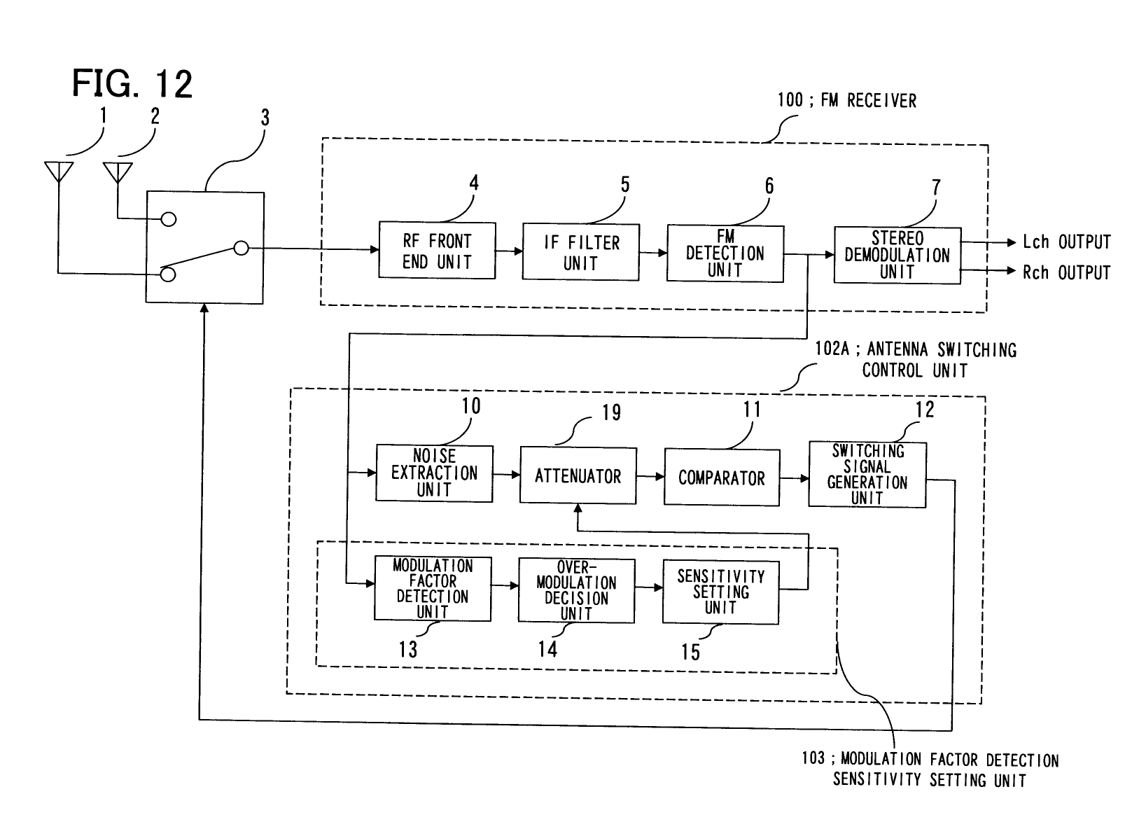

FIG. 12 is a diagram showing a configuration of a fifth exemplary embodiment of the present invention. Referring to FIG. 12, in the present exemplary embodiment, an antenna switching control unit 102A includes an attenuator 19 between a noise extraction unit 10 and a comparator 11. An output of a sensitivity setting unit 15 of a modulation factor detection sensitivity setting unit 103 is supplied to the attenuator 19 to control an attenuation factor of the attenuator 19.

In the abovementioned first exemplary embodiment, when over-modulation is detected by an over-modulation decision unit 14, the sensitivity setting unit 15 sets a threshold for the comparator 11 to be high, but in the present exemplary embodiment, when over-modulation is judged by the over-modulation decision unit 14, the sensitivity setting unit 15 makes the attenuation factor in the attenuator 19 large. As a result, the attenuator 19 attenuates level of noise extracted by the noise extraction unit 10 to a larger extent than when there is no over-modulation. The attenuated noise level is supplied to the comparator 11. Therefore, in the comparator 11, the noise level is less than a multipath detection threshold (fixed), and, when there is over-modulation, a decision of “multipath interference is present” is not outputted from the comparator 11 and antenna switching is not carried out.

On the other hand, when over-modulation is not judged by the over-modulation decision unit 14, the sensitivity setting unit 15 makes the attenuation factor in the attenuator 19 small. In the comparator 11, when the noise level is larger than the multipath detection threshold (fixed), a decision of “multipath interference is present” is outputted, and a switching signal generation unit 12 outputs an antenna switching signal. On the other hand, when the noise level is smaller than the multipath detection threshold (fixed), a decision of “multipath interference is present” is not outputted, and antenna switching is not carried out.

In the present exemplary embodiment, the modulation factor detection sensitivity setting unit 103 may be realized as the modulation factor detection sensitivity setting unit 103A of the second exemplary embodiment, or as the modulation factor detection sensitivity setting unit 103B of the third exemplary embodiment.

### Exemplary Embodiment 6

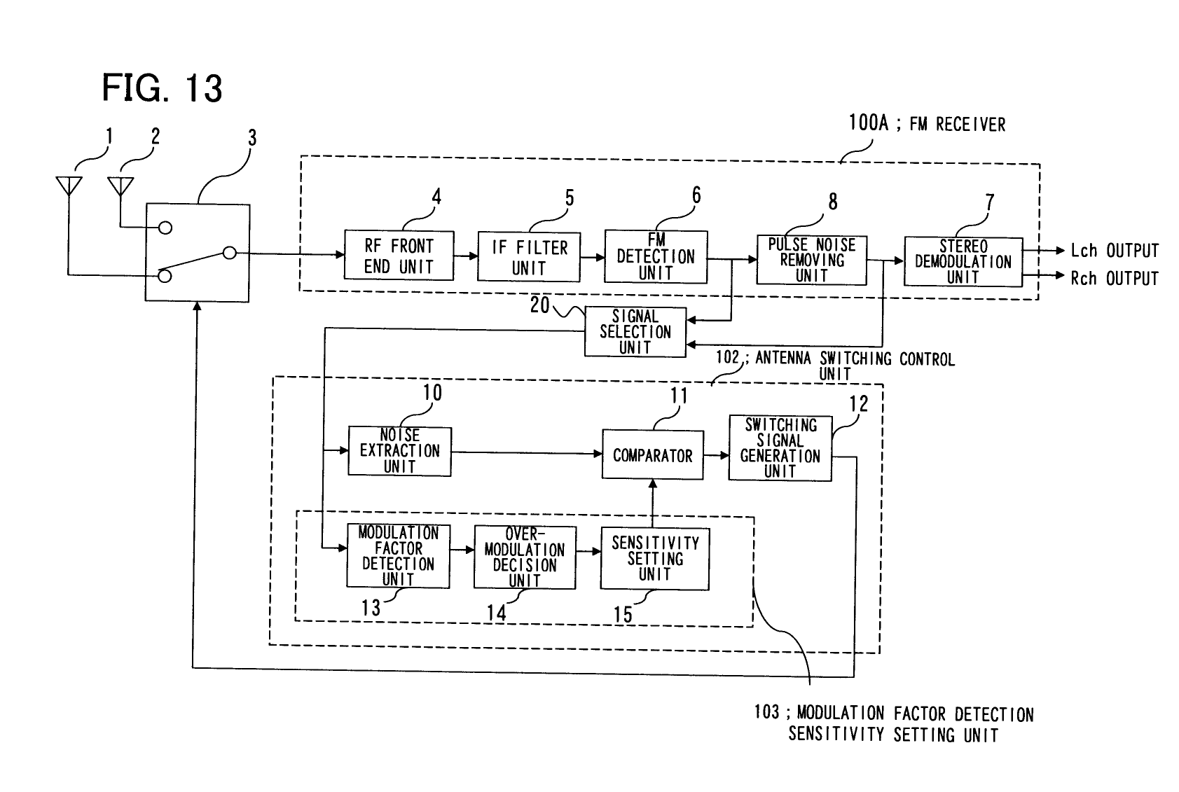

FIG. 13 is a diagram showing a configuration of a sixth exemplary embodiment of the present invention. Referring to FIG. 13, in the present exemplary embodiment, a pulse noise removing unit 8 that removes pulse noise is provided between an FM detection unit 6 and a stereo demodulation unit 7, and also provided is a signal selection unit 20 that selects and outputs one of output detected by the FM detection unit 6 and output of the pulse noise removing unit 8. Output of the signal selection unit 20 is received by a noise extraction unit 10 and a modulation factor detection unit 13 of an antenna switching control unit 102. In FIG. 13, the antenna switching control unit 102 is configured as in the first exemplary embodiment, but clearly may also be configured as in the second to the fifth exemplary embodiments. A selection by the signal selection unit 20 may be configured to be set manually by an operation button or the like of the FM receiver, or to be set in a fixed manner in advance.

In the abovementioned modes and in the abovementioned first to sixth exemplary embodiments, the FM receiver and the antenna switching control unit may be realized by any program (software) that operates by an analog circuit, a digital circuit, or a DSP (digital signal processor), or the like, or may be realized by a combination of these.

The various disclosures of the abovementioned Patent Documents are incorporated herein by reference thereto. Modifications and adjustments of embodiments and examples are possible within the bounds of the entire disclosure (including the scope of the claims) of the present invention, and also based on fundamental technological concepts thereof. Furthermore, a wide variety of combinations and selections of various disclosed elements are possible within the scope of the claims of the present invention. That is, the present invention clearly includes every type of transformation and modification that a person skilled in the art can realize according to the entire disclosure, including the scope of the claims, and technological concepts thereof.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. An antenna diversity receiver comprising:
an FM detection unit that detects a received signal; and
an antenna switching control unit that, when a modulation factor obtained from an output of the FM detection unit is higher than a prescribed threshold, performs control to decrease sensitivity of detection of multipath interference to inhibit antenna switching.

2. The antenna diversity receiver according to claim 1, wherein the antenna switching control unit comprises:
a multipath interference detection unit that detects multipath interference from the output of the FM detection unit;
a switching signal generation unit that, when the multipath interference is detected by the multipath interference detection unit, generates a signal directing switching from one antenna currently being used for reception to another antenna to deliver the generated signal to an antenna switching unit; and
a modulation factor detection sensitivity setting unit that, when the modulation factor is higher than the prescribed threshold, controls setting so as to decrease sensitivity of detection of the multipath interference in the multipath interference detection unit.

3. The antenna diversity receiver according to claim 2, wherein the multipath interference detection unit comprises:
a noise extraction unit that extracts noise from the output of the FM detection unit; and
a comparator that compares level of noise extracted by the noise extraction unit and a multipath detection threshold for detecting multipath interference to make a decision on whether or not multipath interference is present, a decision result output from the comparator being supplied to the switching signal generation unit.

4. The antenna diversity receiver according to claim 3, wherein the modulation factor detection sensitivity setting unit comprises:
a modulation factor detection unit that obtains a modulation factor from the output of the FM detection unit;
an over-modulation decision unit that decides whether or not there is over-modulation in which the modulation factor is higher than the prescribed threshold; and
a sensitivity setting unit that, when the over-modulation decision unit decides that there is over-modulation, changes a value of a multipath detection threshold for detecting multipath interference in the comparator and makes a setting so as to decrease sensitivity of detection of the multipath interference.

5. The antenna diversity receiver according to claim 4, wherein the sensitivity setting unit sets the multipath detection threshold to a first threshold, when the over-modulation decision unit does not decide that there is over-modulation, and sets the multipath detection threshold to a second threshold larger than the first threshold, when the over-modulation decision unit decides that there is over-modulation.

6. The antenna diversity receiver according to claim 4, wherein the modulation factor detection sensitivity setting unit further includes
a time constant processing unit that changes a value of the multipath detection threshold accompanied by a time constant, when the value of the multipath detection threshold from the sensitivity setting unit is changed, an output of the time constant processing unit being supplied to the comparator as the multipath detection threshold.

7. The antenna diversity receiver according to claim 3, wherein the modulation factor detection sensitivity setting unit comprises:
a modulation factor detection unit that obtains a modulation factor from the output of the FM detection unit; and
a level conversion unit that receives the modulation factor as input and produces a value, the magnitude of which corresponds to the magnitude of the modulation factor, as a multipath detection threshold for detecting multipath interference, an output of the level conversion unit being supplied to the comparator as a multipath detection threshold.

8. The antenna diversity receiver according to claim 7, further comprising:
a time constant processing unit that changes a value of the multipath detection threshold accompanied by a time constant, when the value of the multipath detection threshold from the level conversion unit is changed, an output of the time constant processing unit being supplied to the comparator as the multipath detection threshold.

9. The antenna diversity receiver according to claim 7, wherein the level conversion unit outputs a value of a predetermined function, as the multipath detection threshold for the modulation factor, the function, with the modulation factor as a variable, monotonically increasing with regard to the variable, the function assuming a value between a first threshold and a second threshold larger than the first threshold.

10. The antenna diversity receiver according to claim 5, wherein the sensitivity setting unit, when the modulation factor is greater than or equal to a predetermined prescribed value larger than the prescribed threshold, sets the multipath detection threshold to a value larger than the second threshold.

11. The antenna diversity receiver according to claim 9, wherein the level conversion unit, when the modulation factor is greater than or equal to a predetermined prescribed value larger than the prescribed threshold, sets the multipath detection threshold to a value larger than the second threshold.

12. The antenna diversity receiver according to claim 2, wherein the modulation factor detection sensitivity setting unit, when the modulation factor is greater than or equal to a predetermined prescribed value larger than the prescribed threshold, performs control so as to cause the switching signal generation unit to stop antenna switching.

13. The antenna diversity receiver according to claim 3, wherein the antenna switching control unit comprises
a sensitivity selection unit that selects a maximum multipath detection threshold out of
a multipath detection threshold set by the modulation factor detection sensitivity setting unit, and
one or a plurality of multipath detection thresholds set based on a result of analysis of a received signal,
the sensitivity selection unit setting the selected maximum multipath detection threshold to the comparator.

14. The antenna diversity receiver according to claim 13, wherein the antenna switching control unit further comprises:
one or both of an electric field strength detection sensitivity setting unit and an adjacent interference strength detection sensitivity setting unit; and
a sensitivity selection unit, wherein
the electric field strength detection sensitivity setting unit detects electric field strength and, when the electric field strength is lower than a prescribed threshold, changes a multipath detection threshold for detecting multipath interference in the comparator to perform setting to lower sensitivity of detection of the multipath interference,
the adjacent interference strength detection sensitivity setting unit detects adjacent interference strength and, when the adjacent interference strength is higher than a prescribed threshold, changes a multipath detection threshold for detecting multipath interference in the comparator to perform setting to lower sensitivity of detection of the multipath interference, and
the sensitivity selection unit receives as input a multipath detection threshold set by one or both of the electric field strength detection sensitivity setting unit and the adjacent interference strength detection sensitivity setting unit, and a multipath detection threshold set by the modulation factor detection sensitivity setting unit, and selects a maximum multipath detection threshold out of the received multipath detection thresholds,
the sensitivity selection unit setting the selected the maximum multipath detection threshold in the comparator.

15. The antenna diversity receiver according to claim 2, wherein the multipath interference detection unit comprises:
a noise extraction unit that extracts noise from the output of the FM detection unit;
an attenuator that attenuates an output of the noise extraction unit; and
a comparator that compares level of noise outputted from the attenuator and a multipath detection threshold for detecting multipath interference, to decide whether or not there is multipath interference present, a result of a decision by the comparator being supplied to the switching signal generation unit,
the modulation factor detection sensitivity setting unit, when the modulation factor is higher than the prescribed threshold, changing an attenuation factor of the attenuator, and performing control to decrease sensitivity of detection of the multipath interference in the comparator.

16. The antenna diversity receiver according to claim 2, comprising:
a pulse noise removing circuit that removes pulse noise from the output of the FM detection unit; and
a signal selection unit that selects one of an output of the FM detection unit and an output of the pulse noise removing circuit, wherein
the multipath interference detection unit detects multipath interference with respect to noise extracted from an output of the signal selection unit, and
the modulation factor detection sensitivity setting unit obtains a modulation factor from the output of the signal selection unit and, when the modulation factor is higher than the prescribed threshold, performs control to decrease sensitivity of detection of the multipath interference in the multipath interference detection unit.

17. An antenna switching control method for an antenna diversity receiver, the method comprising:
obtaining a modulation factor from an FM detection output, and
performing control to decrease sensitivity for detecting multipath interference to inhibit antenna switching.

18. The antenna switching control method according to claim 17, comprising:
detecting a multipath interference from the FM detection output;
generating a signal directing switching from one antenna currently being used for reception to another antenna, when the multipath interference is detected; and
decreasing sensitivity of detection of the multipath interference, when the modulation factor is higher than the prescribed threshold.

19. The antenna switching control method according to claim 18, comprising, in detecting a multipath interference from the FM detection output,
extracting noise from the FM detection output; and
comparing level of the noise extracted and a multipath detection threshold for detecting multipath interference to make a decision on whether or not multipath interference is present, the signal directing switching of the antenna being generated based on a result of the decision.

20. The antenna diversity receiver according to claim 19, comprising:
obtaining a modulation factor from the FM detection output;
deciding whether or not there is over-modulation in which the modulation factor is higher than the prescribed threshold; and
changing a value of a multipath detection threshold for detecting multipath interference, when it is decided that there is over-modulation, and making a setting so as to decrease sensitivity of detection of the multipath interference.
